(19) United States
(12) Patent Application Publication
(10) Pub. No.: US 2016/0224864 A1
(43) Pub. Date: Aug. 4, 2016

(54) OBJECT DETECTING METHOD AND APPARATUS BASED ON FRAME IMAGE AND MOTION VECTOR

(71) Applicant: Electronics and Telecommunications Research Institute, Daejeon (KR)

(72) Inventors: Won Il CHANG, Daejeon (KR); Jeong Woo SON, Daejeon (KR); Sun Joong KIM, Daejeon (KR); Hwa Suk KIM, Daejeon (KR); So Yung PARK, Daejeon (KR); Alex LEE, Daejeon (KR); Kyong Ha LEE, Daejeon (KR); Kee Seong CHO, Daejeon (KR)

(21) Appl. No.: 15/003,331

(22) Filed: Jan. 21, 2016

(30) Foreign Application Priority Data
Jan. 29, 2015 (KR) 10-2015-0014534

(51) Int. Cl. G06K 9/48; G06K 9/46; G06T 7/20; G06T 7/00

(52) U.S. Cl. CPC G06K 9/481; G06T 7/0081; G06K 9/4652; G06T 7/2033; G06T 2207/20021; G06K 2009/485; G06T 2207/10016

(57) ABSTRACT

Provided is an object detecting method and apparatus, the apparatus configured to extract a frame image and a motion vector from a video, generate an integrated feature vector based on the frame image and the motion vector, and detect an object included in the video based on the integrated feature vector.

### CROSS-REFERENCE TO RELATED APPLICATION

This application claims the priority benefit of Korean Patent Application No. 10-2015-0014534, filed on Jan. 29, 2015, in the Korean Intellectual Property Office, the disclosure of which is incorporated herein by reference.

### BACKGROUND

1. Field of the Invention

Embodiments relate to an object detecting method and apparatus, and more particularly, to detect an object included in a video based on a frame image and a motion vector.

2. Description of the Related Art

Recently, due to generalization of security equipments such as a closed circuit television (CCTV) and rapid increase in multimedia contents, significance in image recognition technology of a video, for example, broadcast contents and a recorded image of a CCTV has increased.

In general, video-based image recognition technology includes technology based on a stopped image and technology based on consecutive frame images. The technology based on a stopped image may divide a video into stopped images in a frame unit, and detect and recognize an object by applying image-based analyzing technology to each stopped image. The technology based on consecutive frame images may recognize a predetermined event or detect a moving object by modeling a motion feature of the object based on the frame images.

However, high-speed recognition is limited due to complexity and an excessive amount of calculation of a plurality of consecutive frame image models or a plurality of condition models. The image recognition technology in a security field using a CCTV provides technology for separating and recognizing a moving object in a video of which a background is fixed. However, the image recognition technology has a limitation of detecting a predetermined object or separating an object from a moving background.

### SUMMARY

An embodiment provides a method and apparatus for efficiently detecting an object included in a video based on a static feature and a dynamic feature of the object, by detecting the object included in the video based on an integrated feature vector.

Another embodiment also provides a method and apparatus for efficiently decreasing an amount of calculating and detecting an object in high speed by combining calculation efficiency, simplicity in object detecting based on a still image, and high performance in object detecting based on a plurality of consecutive frame images.

Still another embodiment also provides a method and apparatus for, having higher accuracy, detecting an object having a regular motion pattern by combining image information of an object included in a still image and motion information of an object, for example, information on an entire or partial motion and deformation of an object.

A further embodiment also provides a method and apparatus for detecting an object robust against blurring in a video in which an object is photographed, in consideration of a static feature of an object based on a frame image and a dynamic feature of an object based on a motion vector.

According to an aspect, there is provided an object detecting method including extracting a frame image and a motion vector from a video, generating an integrated feature vector based on the frame image and the motion vector, and detecting an object included in the video based on the integrated feature vector.

The generating of the integrated feature vector may include extracting a statistical feature of the frame image as a first feature vector and extracting a statistical feature of the motion vector as a second feature vector, and generating the integrated feature vector by combining the first feature vector and the second feature vector.

The extracting of the first feature vector and the second feature vector may include dividing the frame image and the motion vector into a plurality of blocks, extracting the first feature vector based on the frame image included in each of the blocks, and extracting the second feature vector based on the motion vector included in each of the blocks.

The extracting of the first feature vector and the second feature vector may include extracting the first feature vector based on a gradient of brightness in a pixel included in the frame image.

The extracting of the first feature vector and the second feature vector may include extracting the first feature vector based on a level of brightness in a pixel included in the frame image.

The extracting of the first feature vector and the second feature vector may include extracting the first feature vector based on a color of a pixel included in the frame image.

The extracting of the first feature vector and the second feature vector may include extracting the second feature vector based on a direction of the motion vector.

The extracting of the frame image and the motion vector may include dividing a reference frame corresponding to the frame image into a plurality of blocks, generating a motion vector map by extracting the motion vector for each of the blocks, and normalizing sizes of the blocks including the motion vector map.

The detecting of the object included in the video may include detecting the object included in the video by verifying whether an object to be detected is included in the frame image based on the integrated feature vector.

The extracting of the frame image and the motion vector may include extracting the motion vector included in the video in a decoding process or extracting the motion vector based on a plurality of consecutive frame images included in the video.

According to another aspect, there is provided an object detecting apparatus including an extractor configured to extract a frame image and a motion vector from a video, a feature generator configured to generate an integrated feature vector based on the frame image and the motion vector, and an object detector configured to detect an object included in the video based on the integrated feature vector.

The feature generator may be configured to extract a statistical feature of the frame image as a first feature vector and extract a statistical feature of the motion vector as a second feature vector, and generate the integrated feature vector by combining the first feature vector and the second feature vector.

The feature generator may be configured to divide the frame image and the motion vector into a plurality of blocks, extract the first feature vector based on the frame image included in each of the blocks, and extract the second feature vector based on the motion vector included in each of the blocks.

The feature generator may be configured to extract the first feature vector based on a gradient of brightness in a pixel included in the frame image.

The feature generator may be configured to extract the first feature vector based on a level of brightness in a pixel included in the frame image.

The feature generator may be configured to extract the first feature vector based on a color of a pixel included in the frame image.

The feature generator may be configured to extract the second feature vector based on a direction of the motion vector.

The extractor may be configured to divide a reference frame corresponding to the frame image into a plurality of blocks, and generate a motion vector map by extracting the motion vector for each of the blocks, and normalize sizes of the blocks including the motion vector map.

The object detector may be configured to detect the object included in the video by verifying whether an object to be detected is included in the frame image based on the integrated feature vector.

The extractor may be configured to extract the motion vector included in the video in a decoding process or extract the motion vector based on a plurality of consecutive frame images included in the video.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a flowchart illustrating an object detecting method according to an embodiment;

FIG. 2 is a flowchart illustrating a process of generating an integrated feature vector according to an embodiment;

FIG. 3 is a diagram illustrating an example of generating an integrated feature vector from a video according to an embodiment; and

FIG. 4 is a block diagram illustrating a configuration of an object detecting apparatus according to an embodiment.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

Hereinafter, embodiments of the present invention will be described with reference to the accompanying drawings. The detailed description to be disclosed in the following with the accompanying drawings is provided to describe the embodiments and is not to describe a sole embodiment capable of implementing the present invention. The following description may include specific details to provide the full understanding of the present invention. However, it will be apparent to a person of ordinary skill that the present invention may be carried out even without the specific details.

The following embodiments may be provided in a form in which constituent elements and features of the present invention are combined. Each constituent element or feature may be construed to be selective unless explicitly defined. Each constituent element or feature may be implemented without being combined with another constituent element or feature. Also, the embodiments may be configured by combining a portion of constituent elements and/or features. Orders of operations described in the embodiments may be changed. A partial configuration or feature of a predetermined embodiment may be included in another embodiment, and may also be changed with a configuration or a feature corresponding to the other embodiment.

Predetermined terminologies used in the following description are provided to help the understanding of the present invention and thus, use of predetermined terminology may be changed with another form without departing from the technical spirit of the present invention.

In some cases, a known structure and device may be omitted or may be provided as a block diagram based on a key function of each structure and device in order to prevent the concept of the present invention from being ambiguous. In addition, like reference numerals refer to like constituent elements throughout the present specification.

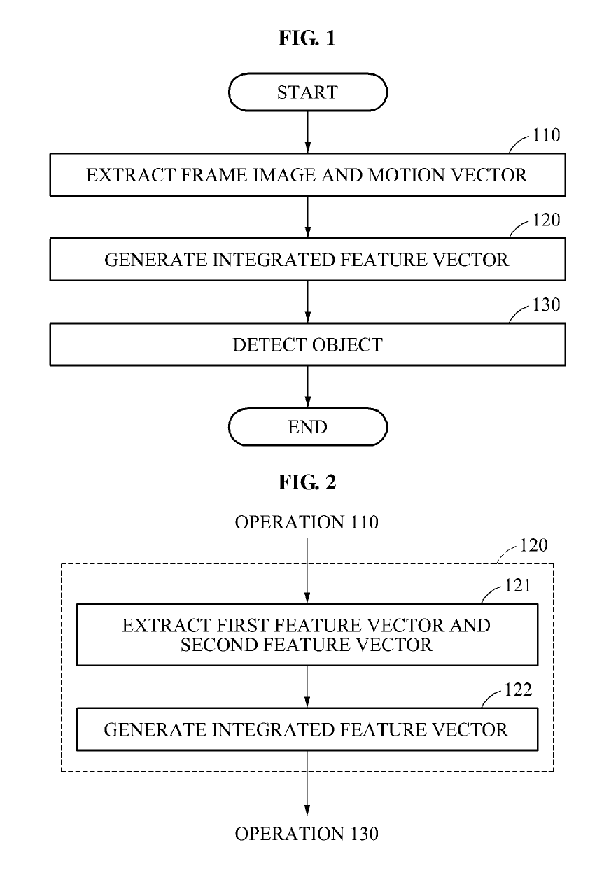

FIG. 1 is a flowchart illustrating an object detecting method according to an embodiment.

The object detecting method according to an embodiment may be performed by a processor included in an object detecting apparatus. For example, the object detecting apparatus is an apparatus for detecting an object included in a video. The object detecting apparatus may be provided in a form of a software module, a hardware module, or various combinations thereof. The object detecting apparatus may be equipped in various computing devices and/or systems, such as smartphones, tablet computers, laptop computers, desktop computers, televisions, wearable devices, security systems, and smart home systems.

In operation 110, the object detecting apparatus extracts a frame image and a motion vector from a video. The video may include a plurality of consecutive frame images. The video may be provided in various forms, for example, streams, files, and broadcasting signals.

The object detecting apparatus extracts the frame image from the video. The object detecting apparatus may extract a predetermined frame image by extracting a plurality of frame images included in the video.

The object detecting apparatus extracts the motion vector from the video. In an example, the object detecting apparatus may extract a motion vector included in a video in a decoding process of the video. The motion vector included in the video may be generated in an encoding process of the video.

In another example, the object detecting apparatus may extract the motion vector from the video using a motion vector calculation algorithm In detail, the object detecting apparatus may calculate an optical flow from the plurality of consecutive frame images extracted from the video. The object detecting apparatus may extract the motion vector based on the calculated optical flow. In this example, the object detecting apparatus may divide a reference frame into a plurality of blocks and generate a motion vector map by extracting the motion vector for each corresponding block. The reference frame refers to a frame to extract a motion vector, the frame corresponding to an image frame.

Sizes of the plurality of blocks including the motion vector map may be irregular. In this case, the object detecting apparatus may adjust the sizes of the plurality of blocks including the motion vector map to be a smallest size of a block among the sizes of the plurality of blocks. The object detecting apparatus normalizes the sizes of the blocks including the motion vector map.

In operation 120, the object detecting apparatus generates an integrated feature vector based on the frame image and the motion vector. The object detecting apparatus extracts a first feature vector from the frame image and a second feature vector from the motion vector. The object detecting apparatus generates the integrated feature vector based on the first feature vector and the second feature vector.

In an example, the object detecting apparatus divides the frame image and the motion vector into the plurality of blocks, extracts the first feature vector from the frame image included in each of the blocks, and extracts the second feature vector from the motion vector included in each of the blocks. The object detecting apparatus may generate the integrated feature vector corresponding to blocks by combining the first feature vector and the second feature vector extracted from the corresponding blocks.

A detailed process of generating the integrated feature vector will be described with reference to FIG. 2.

In operation 130, the object detecting apparatus detects an object included in the video based on the integrated feature vector. The object detecting apparatus detects the object included in the video by verifying whether an object to be detected is included in the frame image based on the integrated feature vector. The object to be detected refers to a moving object included in a video. The object to be detected may be included in a portion area of the frame image, and included in the plurality of blocks or a single block among the divided blocks.

In an example, when an object to be detected is a single object, the object detecting apparatus may detect an object included in a video using various recognizers, for example, a logistic regression, support vector machine (SVM), and a latent SVM. In another example, the object detecting apparatus may replace an image part model with an image-motion combination feature-based part model, in a deformable part model. Accordingly, the object detecting apparatus may separate a moving object from a background by performing modeling on an object having a regular motion. Therefore, the object detecting apparatus may detect an object having a regular motion, for example, a rotating car wheel and a leg of a walking person.

FIG. 2 is a flowchart illustrating a process of generating an integrated feature vector according to an embodiment.

Operation 120 performed by the object detecting apparatus is divided into following operations.

In operation 121, the object detecting apparatus extracts a first feature vector from a frame image and extracts a second feature vector from a motion vector. The object detecting apparatus extracts a statistical feature of the frame image as the first feature vector and extracts a statistical feature of the motion vector as the second feature vector.

The object detecting apparatus divides the frame image and the motion vector into a plurality of blocks. The object detecting apparatus generates an integrated feature vector corresponding to the blocks by extracting the first feature vector and the second feature vector corresponding to each of the divided blocks.

In an example, the object detecting apparatus may detect a first feature vector based on a gradient of brightness in a pixel included in a frame image. The object detecting apparatus may extract the first feature vector based on a histogram with respect to the gradient of the brightness in the pixel.

In another example, the object detecting apparatus may extract a first feature vector based on a level of brightness in a pixel included in a frame image. The object detecting apparatus may extract the first feature vector based on a histogram with respect to the level of the brightness in the pixel.

In still another example, the object detecting apparatus may extract a first feature vector based on a color of a pixel included in a frame image. The object detecting apparatus may extract the first feature vector based on a histogram with respect to the color of the pixel.

In an example, the object detecting apparatus extracts a second feature vector based on a direction of a motion vector. The object detecting apparatus may extract the second feature vector based on a histogram with respect to the direction of at least one motion vector corresponding to each of the divided blocks. For example, when the motion vector included in each of the divided blocks is provided in plural, the object detecting apparatus may calculate motion vectors included in each of the blocks and extract the second feature vector based on a direction of the calculated motion vectors.

In operation 122, the object detecting apparatus generates the integrated feature vector by combining the first feature vector and the second feature vector. The integrated feature vector is referred to as a feature vector based on the first feature vector and the second feature vector. The object detecting apparatus may detect an object based on a static feature and a dynamic feature of an object included in a video, using the integrated feature vector.

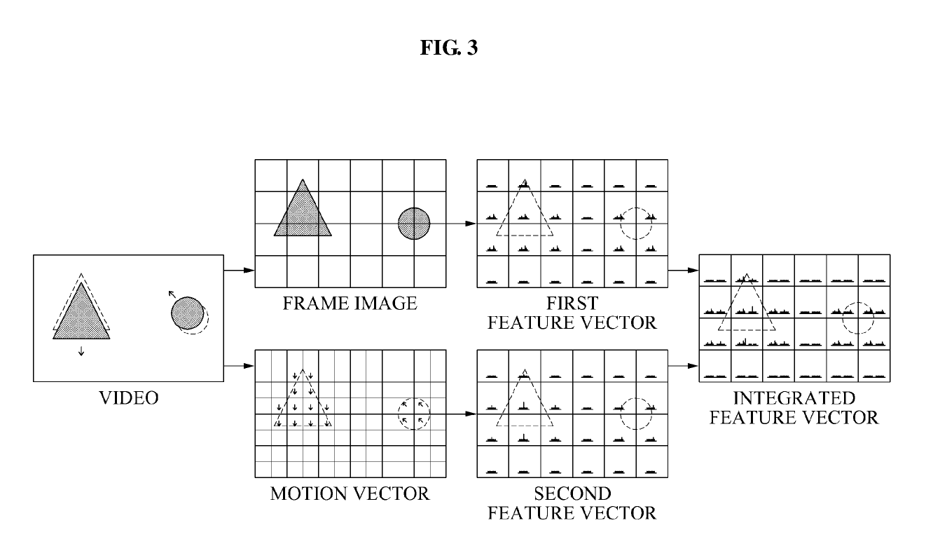

FIG. 3 is a diagram illustrating an example of generating an integrated feature vector from a video according to an embodiment.

According to an embodiment, a triangle object and a circle object are included in a video illustrated in FIG. 3. FIG. 3 illustrates a case in which the triangle object moves downward, and the circle object moves toward upper left. In the video illustrated in FIG. 3, a solid line represents an object moved for a predetermined time after an object indicated by a dotted line.

An object detecting apparatus detects a frame image from a video. The object detecting apparatus may extract a predetermined frame image by extracting a plurality of frame images that are timely consecutive included in the video. The object detecting apparatus may statically analyze an object included in the video based on the extracted frame image.

The object detecting apparatus extracts a motion vector from the video. In an example, the object detecting apparatus may extract, from a video, a motion vector generated in an encoding process. In another example, the object detecting apparatus may extract a motion vector from a plurality of frame images that are temporally consecutive images included in the video. In this example, the object detecting apparatus may extract the motion vector using a motion vector algorithm, such as an optical flow calculation. The object detecting apparatus may divide a reference frame into a plurality of blocks and separately extract a motion vector corresponding to each of the blocks.

For example, the object detecting apparatus may extract a motion vector corresponding to each of blocks based on a difference of a color of an image corresponding to each of the blocks. The object detecting apparatus may compare a previous image to a current image corresponding to the blocks. When a color difference between the previous image and the current image is greater than a predetermined value, the object detecting apparatus may extract a motion vector of the block by identifying a reference object based on a portion in which the color difference is present and calculating the motion vector with respect to the motion of the reference object. The object detecting apparatus may generate a motion vector map using the extracted motion vector. When sizes of the blocks including the motion vector map are irregular, the object detecting apparatus may normalize the sizes of the blocks included in the motion vector map based on a smallest block size.

The object detecting apparatus may dynamically analyze the object included in the video based on the motion vector.

The object detecting apparatus extracts a first feature vector from the extracted frame image. The object detecting apparatus divides the frame image into the plurality of blocks, and extracts the first feature vector with respect to each of the blocks based on the frame image corresponding to each of the blocks. In an example, the first feature vector with respect to each of the blocks may be extracted based on a histogram with respect to a gradient of brightness in a pixel included in the blocks. In another example, the first feature vector with respect to each of the blocks may be extracted based on a histogram with respect to a level of brightness in a pixel included in the blocks. In still another example, the first feature vector with respect to each of the blocks may be extracted based on a histogram with respect to a color of a pixel included in the blocks.

The object detecting apparatus detects a second feature vector from the extracted motion vector. The object detecting apparatus may extract the second feature vector based on blocks in identical sizes of blocks of the frame image. The object detecting apparatus may extract the second feature vector corresponding to each of the blocks based on a histogram with respect to a direction of at least one motion vector included in blocks in identical sizes of the blocks dividing the frame image.

The object detecting apparatus generates an integrated feature vector by combining the first feature vector and the second feature vector. Blocks corresponding to the first feature vector and blocks corresponding to the second feature vector may have an identical size. The object detecting apparatus may combine the first feature vector and the second feature vector corresponding to each of the blocks based on blocks. Concisely, the object detecting apparatus may generate the integrated feature vector for each area.

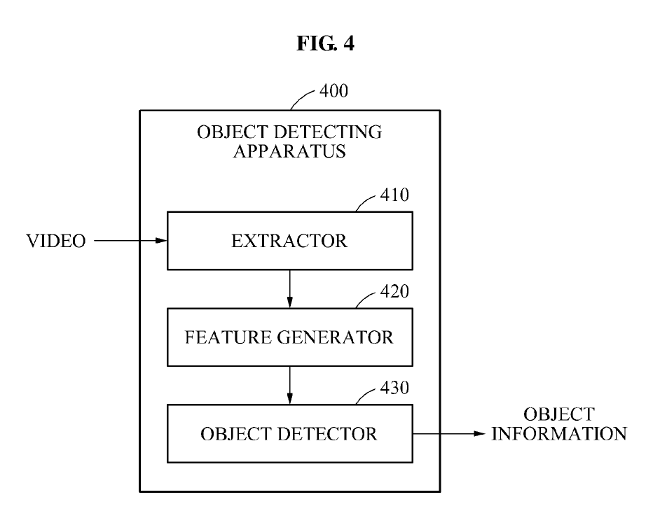

FIG. 4 is a block diagram illustrating a configuration of an object detecting apparatus according to an embodiment.

Referring to FIG. 4, an object detecting apparatus 400 includes an extractor 410, a feature generator 420, and an object detector 430. The object detecting apparatus 400 is an apparatus for detecting an object included in a video. The object detecting apparatus 400 may be provided in a form of a software module, a hardware module, or various combinations thereof. The object detecting apparatus 400 may be equipped in various computing devices and/or systems, such as smartphones, tablet computers, laptop computers, desktop computers, televisions, wearable devices, security systems, and smart home systems.

The extractor 410 extracts a frame image and a motion vector from a video. The extractor 410 extracts a predetermined frame image by extracting a plurality of frame images that are temporally consecutive images included in the video.

The extractor 410 may extract the motion vector generated in an encoding process from the video. Alternatively, the extractor 410 may extract the motion vector based on the plurality of frame images that are temporally consecutive images included in the video.

For example, FIG. 4 illustrates that the extractor 410 extracts the frame image and the motion vector. However, this is only an example, and thus an example of the extractor 410 is not limited thereto. The object detecting apparatus 400 may independently include a frame image extractor to extract a frame image from a video and a motion vector extractor to extract a motion vector from the video.

The feature generator 420 generates an integrated feature vector based on the frame image and the motion vector. The feature generator 420 may divide the frame image into a plurality of blocks and extract a first feature vector corresponding to each of the blocks based on the frame image included in the blocks. The feature generator 420 may extract a statistical feature of the frame image as the first feature vector.

In an example, the feature generator 420 may extract the first feature vector corresponding to each of the blocks based on a gradient of brightness in a pixel included in a frame image corresponding to the blocks. In another example, the feature generator 420 may extract the first feature vector corresponding to each of the blocks based on a level of brightness in a pixel included in a frame image. In still another example, the feature generator 420 may extract the first feature vector corresponding to each of the blocks based on a color of a pixel included in a frame image corresponding to the blocks.

The feature generator 420 divides the motion vector into the plurality of blocks and extracts a second feature vector corresponding to each of the blocks based on the motion vector included in the blocks. The feature generator 420 extracts a statistical feature of the motion vector as the second feature vector. For example, the feature generator 420 may extract the second feature vector based on a direction of at least one motion vector included in blocks. Here, blocks dividing the motion vector may have identical sizes of blocks dividing the frame image.

The object detector 430 detects the object included in the video based on the integrated feature vector. The object detector 430 may detect the object included in the video by verifying whether an object to be detected is included in the frame image based on the integrated feature vector. The object detector 430 may output object information about the detected object as a detection result.

Certain forms of technology applicable to the present disclosure may be omitted to avoid ambiguity of the present disclosure. The omitted configurations may be applicable to the present disclosure with reference to “Histograms of oriented gradients for human detection” and “Object Detection with Discriminatively Trained Part Based Models”.

An embodiment may efficiently detect an object included in a video based on a static feature and a dynamic feature of the object, by detecting the object included in the video based on an integrated feature vector.

An embodiment may efficiently decrease an amount of calculating and detect an object in high speed by combining calculating efficiency, simplicity in object detecting based on a still image, and high performance in object detecting based on a plurality of consecutive frame images.

An embodiment may efficiently decrease an amount of calculating and detect an object having a regular pattern in high speed by combining image information of an object included in a still image and motion information of an object, for example, information on an entire or partial motion and deformation of an object.

An embodiment may provide a method and apparatus for detecting an object robust against blurring in a video in which an object is photographed, in consideration of a static feature of an object based on a frame image and a dynamic feature of an object based on a motion vector.

The units described herein may be implemented using hardware components, software components, or a combination thereof. For example, a processing device may be implemented using one or more general-purpose or special purpose computers, such as, for example, a processor, a controller and an arithmetic logic unit (ALU), a digital signal processor, a microcomputer, a field programmable array (FPA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The above-described embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tapes; optical media such as CD ROMs and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An object detecting method comprising:
extracting a frame image and a motion vector from a video;
generating an integrated feature vector based on the frame image and the motion vector; and
detecting an object comprised in the video based on the integrated feature vector.

2. The method of claim 1, wherein the generating of the integrated feature vector comprises,
extracting a statistical feature of the frame image as a first feature vector and extracting a statistical feature of the motion vector as a second feature vector; and
generating the integrated feature vector by combining the first feature vector and the second feature vector.

3. The method of claim 2, wherein the extracting of the first feature vector and the second feature vector comprises,
dividing the frame image and the motion vector into a plurality of blocks, extracting the first feature vector based on the frame image comprised in each of the blocks, and extracting the second feature vector based on the motion vector comprised in each of the blocks.

4. The method of claim 2, wherein the extracting of the first feature vector and the second feature vector comprises,
extracting the first feature vector based on a gradient of brightness in a pixel comprised in the frame image.

5. The method of claim 2, wherein the extracting of the first feature vector and the second feature vector comprises,
extracting the first feature vector based on a level of brightness in a pixel comprised in the frame image.

6. The method of claim 2, wherein the extracting of the first feature vector and the second feature vector comprises,
extracting the first feature vector based on a color of a pixel comprised in the frame image.

7. The method of claim 2, wherein the extracting of the first feature vector and the second feature vector comprises,
extracting the second feature vector based on a direction of the motion vector.

8. The method of claim 1, wherein the extracting of the frame image and the motion vector comprises,
dividing a reference frame corresponding to the frame image into a plurality of blocks, generating a motion vector map by extracting the motion vector for each of the blocks, and normalizing sizes of the blocks comprising the motion vector map.

9. The method of claim 1, wherein the detecting of the object comprised in the video comprises,
detecting the object comprised in the video by verifying whether an object to be detected is comprised in the frame image based on the integrated feature vector.

10. The method of claim 1, wherein the extracting of the frame image and the motion vector comprises,
extracting the motion vector comprised in the video in a decoding process or extracting the motion vector based on a plurality of consecutive frame images comprised in the video.

11. An object detecting apparatus comprising:
an extractor configured to extract a frame image and a motion vector from a video;
a feature generator configured to generate an integrated feature vector based on the frame image and the motion vector; and
an object detector configured to detect an object comprised in the video based on the integrated feature vector.

12. The apparatus of claim 11, wherein the feature generator is configured to extract a statistical feature of the frame image as a first feature vector and extract a statistical feature of the motion vector as a second feature vector, and generate the integrated feature vector by combining the first feature vector and the second feature vector.

13. The apparatus of claim 12, wherein the feature generator is configured to divide the frame image and the motion vector into a plurality of blocks, extract the first feature vector based on the frame image comprised in each of the blocks, and extract the second feature vector based on the motion vector comprised in each of the blocks.

14. The apparatus of claim 12, wherein the feature generator is configured to extract the first feature vector based on a gradient of brightness in a pixel comprised in the frame image.

15. The apparatus of claim 12, wherein the feature generator is configured to extract the first feature vector based on a level of brightness in a pixel comprised in the frame image.

16. The apparatus of claim 12, wherein the feature generator is configured to extract the first feature vector based on a color of a pixel comprised in the frame image.

17. The apparatus of claim 12, wherein the feature generator is configured to extract the second feature vector based on a direction of the motion vector.

18. The apparatus of claim 11, wherein the extractor is configured to divide a reference frame corresponding to the frame image into a plurality of blocks, and generate a motion vector map by extracting the motion vector for each of the blocks, and normalize sizes of the blocks comprising the motion vector map.

19. The apparatus of claim 11, wherein the object detector is configured to detect the object comprised in the video by verifying whether an object to be detected is comprised in the frame image based on the integrated feature vector.

20. The apparatus of claim 11, wherein the extractor is configured to extract the motion vector comprised in the video in a decoding process or extract the motion vector based on a plurality of consecutive frame images comprised in the video.
